(19) United States
(12) Patent Application Publication
(10) Pub. No.: US 2020/0110426 A1
(43) Pub. Date: Apr. 9, 2020

(54) CONTROL VALVE

(71) Applicant: BELIMO HOLDING AG, Hinwil (CH)

(72) Inventors: Urs KELLER, Hinwil (CH); Dzemil VESELI, Bütschwil (CH); Marc THUILLARD, Uetikon am See (CH)

(73) Assignee: BELIMO HOLDING AG, Hinwil (CH)

(21) Appl. No.: 16/617,907

(22) PCT Filed: Apr. 23, 2018
(86) PCT No.: PCT/EP2018/060355

§ 371 Date: Nov. 27, 2019

(30) Foreign Application Priority Data
Jun. 30, 2017 (CH) 00854/17

(51) Int. Cl. G05D 7/01; F16K 15/18; F16K 11/02

(52) U.S. Cl. CPC G05D 7/012; F16K 11/022; F16K 15/188

(57) ABSTRACT

A control valve (100) for regulating a fluid flow in an HVAC system is described, the control valve (100) comprising a valve housing (11) defining a flow path (12), a valve regulating body (13) arranged in the flow path (12) and being adjustable between a closed position and an open position for the fluid flow, and a flow regulating insert (14) configured to regulate the fluid flow over a range of pressure differences across the flow regulating insert (14), wherein the flow regulating insert (14) comprises a spatially fixed pin (141) and an elastically deformable annular throttling member (142) encompassing at least a part of the pin (141), wherein the annular throttling member (142) defines an orifice (143) in the flow regulating insert (14) for the passage of the fluid flow, the orifice (143) being modifiable by deformation of the annular throttling member (142) under a pressure difference across the flow regulating insert (14).

### TECHNICAL FIELD

The invention relates to a control valve for regulating a fluid flow in an HVAC system and a flow regulating insert for positioning in a flow path of a control valve.

### BACKGROUND OF THE INVENTION

Regulating the fluid flow with a control valve plays an important role in HVAC systems (HVAC: Heating, Ventilating, and Air Conditioning). In particular, it is desired to regulate the flow rate to a certain value over a range of pressure differences across the control valve. Such a so-called pressure-independent control valve has several advantages such as avoidance of over- or undersupply of the devices of the HVAC system, such as individual air conditioners, increased energy efficiency, fast and reliable valve selection etc.

Known solutions for regulating the fluid flow with a control valve typically use a spatially movable regulating body which can reduce the flow rate by cooperating with a valve seat. Such a solution is shown in WO2014/198412 A1, where a pressure equalizing insert for a control valve is described. The pressure equalizing insert comprises a housing having an actuating member which is movably mounted thereon and is configured to at least partially guide the fluid stream regulated by the valve and, when the pressure equalizing insert is installed, co-operates with a valve seat depending upon a pressure difference prevailing in the fluid stream in order to regulate the fluid stream.

Other known solutions are directed to the self-deformation of elastic members as shown for example in U.S. Pat. No. 2,454,929 where a fluid control device is described. The fluid control device comprises a seat member having a central opening being defined by at least one frusto-conical surface, and a resilient annular member seated on the seat member over the opening. The annular member has a central opening substantially aligned with the opening in the seat member. The frusto-conical surface of the seat member defines at least a part of the opening of the seat member and is arranged to diverge toward the resilient annular member. The frusto-conical surface terminates adjacent the resilient annular member at a point spaced radially outwardly from the opening of the resilient annular member. The central portion of the annular member is deflectable by fluid pressure into the frusto-conical portion of the seat member opening.

The solutions known from the prior art have either a sophisticated structure or are limited in performance in terms of available flow rates or operable pressure ranges.

### SUMMARY OF THE INVENTION

It is an object of the invention to provide a control valve for regulating the fluid flow in an HVAC system and a flow regulating insert for positioning in a flow path of a control valve, which at least partially improve the prior art and avoid at least part of the mentioned disadvantages of the prior art.

According to the present invention, this object is achieved by the features of the independent claims. In addition, further advantageous embodiments follow from the dependent claims and the description.

According to an aspect of the invention, the object is particularly achieved by a control valve for regulating a fluid flow in an HVAC system, the control valve comprising a valve housing defining a flow path, a valve regulating body arranged in the flow path and being adjustable between a closed position and an open position for the fluid flow, and at least one flow regulating insert configured to regulate the fluid flow over a range of pressure differences across the flow regulating insert. The flow regulating insert comprises a spatially fixed pin and an elastically deformable annular throttling member encompassing at least a part of the pin. The annular throttling member defines an orifice in the flow regulating insert for the passage of the fluid flow, the orifice being modifiable by deformation of the annular throttling member under a pressure difference across the flow regulating insert.

A part of the orifice may be defined between the annular throttling member and the pin. Another part of the orifice may be defined between the annular throttling member and another part of the flow regulating insert. The pin may comprise a retaining surface, for example formed by bridges, for holding the annular throttling member within the flow regulating insert. The fluid flow may pass between the bridges. In an embodiment, the pin is tapered.

The flow regulating insert provides the advantage that the flow rate may be regulated to a specific value determined by the dimensions of the orifice and characteristics of the annular throttling member, such as for example material or dimensioning. For example, an increasing pressure difference across the flow regulating insert leads to deformation of the annular throttling member reducing the size of the orifice which limits the flow rate. Advantageously, the annular throttling member abuts against a portion of the flow regulating insert, for example the pin and/or a seat formed within the flow regulating insert, while being deformed, which increases the range of pressure differences the flow regulating insert can withstand while regulating the flow without having to increase the thickness of the annular throttling member.

The flow regulating insert has the advantage of a simple structure with reduced susceptibility to malfunctioning compared to for example solutions with a movable insert and a valve seat.

In an embodiment, the flow regulating insert comprises at least two spatially fixed pins and at least two elastically deformable annular throttling members, each encompassing at least a part of one of the pins. By varying the number of pins and annular throttling members, the number of orifices can be changed, such that the overall flow rate can be modified and adapted to the specific requirement of the control valve.

Arranging at least two pins and annular throttling members provides the further advantage that multiple orifices can be achieved in a simple manner which may improve the cavitation properties of the control valve.

The annular throttling member being responsible for modifying the orifice for the fluid flow by deformation provides the advantage that the flow regulating insert may be designed in a compact fashion with a reduced thickness compared to known solutions. Especially, the structure of the flow regulating insert enables a linear design of the control valve, which is typically not the case for solutions with a movable insert. Further, the flow regulating insert provides the advantage that a straight direction of the fluid flow is favored, such that the range where laminar flow prevails can be increased. Moreover, the pressure difference across the flow regulating insert can be kept low compared to known solutions with a movable insert. A laminar flow of the fluid flow has the advantage that flow induced vibration and noise generation are reduced and that flow regulation properties, such as pressure independency, can be improved.

The absence of a movable insert, such as a piston, provides the further advantage that detrimental sag effects can be avoided.

Owing to the annular throttling member encompassing at least a part of the pin and abutting against a part of the flow regulating insert, an increased robustness, increased range of operation and reduced size may be provided compared to solutions relying on self-deformation of an elastic member with a hole within the elastic member.

In an embodiment, the flow regulating insert is designed in a mirror-symmetric fashion with respect to a plane perpendicular to the flow path. This has the advantage that the flow may be regulated independent of the direction of the fluid flow.

In an embodiment, the flow regulating insert comprises a carrier plate extending across the cross-section of the valve housing at the position of the flow regulating insert and comprising a recess for receiving the pin and the annular throttling member, wherein the annular throttling member defines the orifice between the pin and a portion of the carrier plate.

The carrier plate may comprise multiple recesses for receiving pins and annular throttling members. Multiple pins and annular throttling members being received in recesses of a single carrier plate provides the advantage of increased simplicity and robustness of the structure. The recess may be designed in a manner that the pin may be received in a form-fit and/or force-fit manner in the recess. The pin may comprise bridges formed at one end of the pin, the bridges connected at one end to a common fitting ring. The fitting ring may enable the pin to be received in the recess in a form-fit and/or force-fit manner. Especially, the pin may be held in the carrier member regardless to the direction of the fluid flow.

In an embodiment, the carrier plate comprises a recess forming a seat for the annular throttling member. The seat provides the advantage that releasing of the annular throttling member from the flow regulating insert at high pressure differences across the flow regulating insert can be avoided. The annular throttling member may abut against a portion of the seat while being deformed. The portion of the seat may therefore form a bearing surface for the annular throttling member.

In an embodiment, the flow regulating insert comprises a carrier plate extending across the cross-section of the valve housing at the position of the flow regulating insert, wherein the pin is integrally formed with the carrier plate. The pin may be connected with the carrier plate by bridges which form a retaining surface for holding the annular throttling member within the carrier plate. The fluid flow may pass between the bridges.

In an embodiment, the flow regulating insert comprises a frame element for receiving the pin and the annular throttling member, wherein the annular throttling member defines the orifice between the pin and a portion of the frame element, the flow regulating insert comprising a carrier plate extending across the cross-section of the valve housing at the position of the flow regulating insert and comprising a recess for receiving the frame element. For multiple pins and annular throttling members, the flow regulating insert may comprise a frame element for each pin. The pin, annular throttling member and the frame element may form a replaceable flow regulating unit. The frame element may be held in the recess of the carrier plate in a form-fit and/or force-fit manner.

In an embodiment, the flow regulating insert comprises at least two pins and at least two annular throttling members, each encompassing at least a part of one of the two pins, and at least two frame elements, each for receiving one of the two pins and annular throttling members.

In an embodiment, the frame element comprises a recess forming a seat for the annular throttling member. The seat provides the advantage that releasing of the annular throttling member from the flow regulating insert at high pressure differences across the flow regulating insert can be avoided. The annular throttling member may abut against a portion of the seat while being deformed. The portion of the seat may therefore form a bearing surface for the annular throttling member.

In an embodiment, the valve housing comprises a recess for receiving the flow regulating insert. The flow regulating insert may be received in the recess of the control valve in a form-fit manner and/or force-fit manner, such that the fluid flow may be restricted to flow through the orifice defined by the annular throttling member.

In an embodiment, the valve housing comprises a first and second valve housing member, wherein the flow regulating insert is fixedly held between the first and second valve housing member. The flow regulating insert may be held between the first and the second valve housing member in a form-fit and/or force-fit manner. The first or the second valve housing member may comprise a recess for receiving the flow regulating insert. In addition, the first or the second valve housing member may comprise a bearing surface for clamping the flow regulating insert.

In an embodiment, the valve regulating body is rotatable around an axis of rotation between the closed position and the open position for the fluid flow.

Especially, the rotatable valve regulating body may be a ball with a through bore, such that the control valve forms a ball valve. By using multiple pins and annular throttling members in combination with a ball valve, the cavitation properties of the ball valve may be improved by distributing the fluid flow over multiple orifices.

In an embodiment, the flow regulating insert is arranged within the valve regulating body. By placing the flow regulating insert within the valve regulating body, a particularly compact design may be achieved. Further, a control valve with the flow regulating insert arranged within the valve regulating body may particularly be suited for a symmetric design where the flow may be regulated independent of the direction of the fluid flow.

In an embodiment, flow regulating insert is arranged upstream or downstream of the valve regulating body with respect to the flow path.

In an embodiment, the flow regulating insert comprises a recess contributing to the orifice for the passage of the fluid flow. In embodiments with a carrier plate, the carrier plate may comprise a recess contributing to the orifice. In embodiments with a frame element, the frame element may comprise a recess contributing to the orifice. In a variant, the pin comprises a recess contributing to the orifice. A recess contributing to the orifice provides the advantage that the orifice may be modified by compression of at least a part of the annular throttling member into the recess under a pressure difference across the flow regulating insert. The flow rate to which the fluid flow is regulated may be defined by varying the design of the recess contributing to the orifice and/or the dimension of the annular throttling member. The recess may be arranged such that the annular throttling member defines multiple orifices. Dividing the orifice into multiple orifices by the arrangement of the recess provides the advantage that the cavitation properties can be improved.

Preferably, the flow regulating insert is positioned in such a manner that the plane of the annular throttling member extends perpendicular to the flow path.

In an embodiment, the annular throttling member has a diameter of the annulus equal or smaller than half of the inner diameter of the control valve at the position of the flow regulating insert. This dimensioning of the annular throttling member provides the advantage that multiple pins and annular throttling members may be arranged in parallel at the same level in the flow path.

In an embodiment, the control valve is a 6-way valve comprising two consumer ports and four source ports, wherein the four source ports comprise two first source ports for a first fluidic circuit and two second source ports for a second fluidic circuit. The first fluidic circuit may be a cooling circuit and the second fluidic circuit may be a heating circuit. The 6-way valve may comprise a flow regulating insert of the at least one flow regulating insert according to the present invention arranged in at least one of: the two consumer ports and the four source ports.

In an embodiment, the control valve, in particular the 6-way valve, comprises a first flow regulating insert of the at least one flow regulating insert and a second flow regulating insert of the at least one flow regulating insert, wherein the first and second flow regulating inserts are configured to regulate the flow rate to a first and a different second specific value, respectively.

The first flow regulating insert of the at least one flow regulating insert may be arranged in one of the two source ports and the second flow regulating insert of the at least one flow regulating insert may be arranged in one of the two second source ports. There may be therefore a specific flow regulating insert for each fluidic circuit. With the first and second flow regulating inserts, separate regulating of the fluid flow for each fluidic circuit can be achieved. In particular, the two flow regulating inserts can be configured differently from each other to regulate the flow rate for the two fluidic circuits, for example for a hot water and a cold water circuit, to different specific values. Thus, the two flow regulating inserts may comprise different dimensions of the orifice and different characteristics of the annular throttling member, such as for example material or dimensioning.

In an embodiment, the flow regulating insert is arranged in one of the consumer ports, which allows to regulate the fluid flow to the same specific value for both fluidic circuits.

In a variant, one flow regulating insert is arranged in only one of the four source ports, for the case that flow regulation is only required for one of the fluidic circuits.

According to a further aspect, the present invention is also directed to a flow regulating insert for positioning in a flow path of a control valve according to the present invention, comprising a spatially fixed pin and an elastically deformable annular throttling member encompassing at least a part of the pin, wherein the annular throttling member defines an orifice in the flow regulating insert for the passage of the fluid flow, the orifice being modifiable by deformation of the annular throttling member under a pressure difference across the flow regulating insert.

In an embodiment, the flow regulating insert comprises at least two spatially fixed pins and at least two elastically deformable annular throttling members, each encompassing at least a part of one of the pins.

In an embodiment, the flow regulating insert comprises a carrier plate comprising a recess for receiving the pin and the annular throttling member, wherein the annular throttling member defines the orifice between the pin and a portion of the carrier plate.

In an embodiment, the flow regulating insert comprises a frame element for receiving the pin and the annular throttling member, wherein the annular throttling member defines the orifice between the pin and a portion of the frame element, the flow regulating insert comprising a carrier plate comprising a recess for receiving the frame element.

In an embodiment, the flow regulating insert comprises a recess contributing to the orifice for the passage of the fluid flow.

### BRIEF DESCRIPTION OF THE DRAWINGS

The present invention will be explained in more detail, by way of example, with reference to the drawings, in which:

FIG. 1a: shows a side cut view of an embodiment of a control valve;

FIGS. 1b-c: show magnifications of a part of the flow regulating insert of FIG. 1a.

FIG. 1d: shows a front view of the pin of FIG. 1b;

FIG. 2a: shows a side cut view of an embodiment of a flow regulating insert;

FIG. 2b: shows a perspective cut view of the flow regulating insert of FIG. 2a;

FIG. 3a: shows a side cut view of a further embodiment of a flow regulating insert with two pins;

FIG. 3b: shows a rear view of the flow regulating insert of FIG. 3a;

FIG. 4a: shows a rear view of a further embodiment of a flow regulating insert with three pins;

FIG. 4b: shows a side cut view of the flow regulating insert of FIG. 4a;

FIG. 5a: shows a rear view of a further embodiment of a flow regulating insert with four pins;

FIG. 5b: shows a side cut view of the flow regulating insert of FIG. 5a;

FIG. 6: shows a measurement of the flow rate regulated by a control valve according to the present invention;

FIG. 7a: shows a cross-sectional view of a further embodiment of a control valve;

FIG. 7b: shows an exploded perspective view of the control valve of FIG. 7a.

### DETAILED DESCRIPTION OF EXEMPLARY EMBODIMENTS

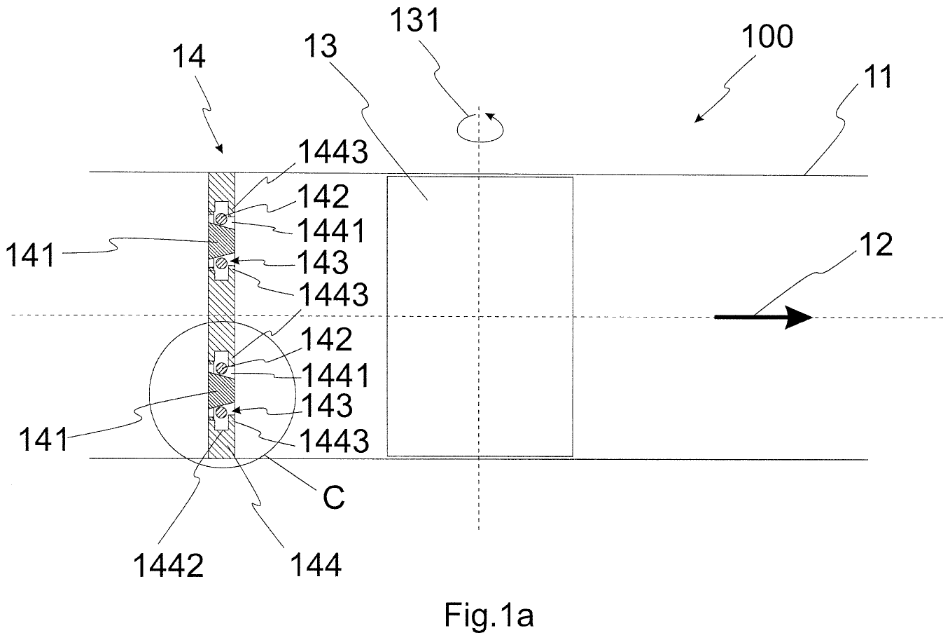

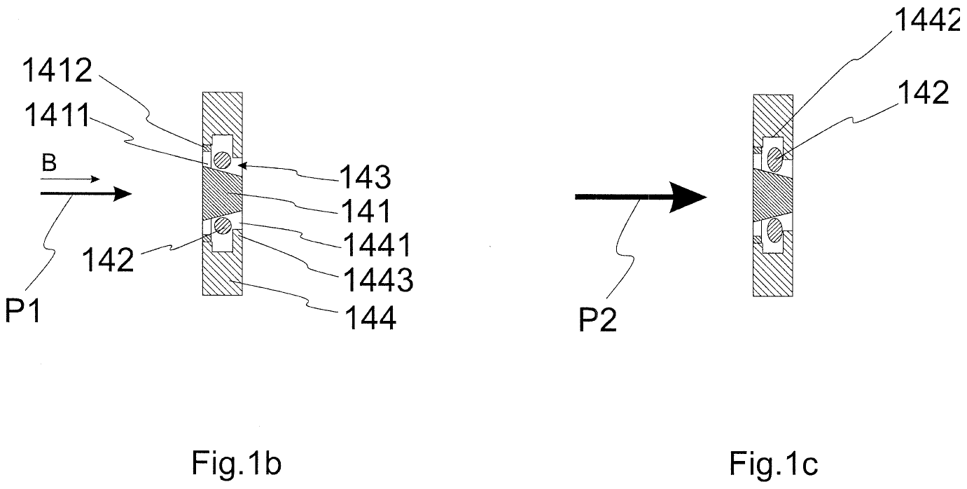

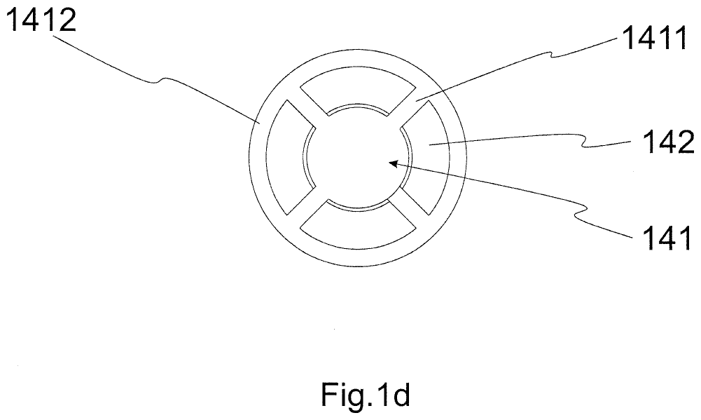

FIG. 1a shows a side cut view of an embodiment of a control valve loo comprising a valve housing 11 defining a flow path 12. The control valve loo comprises a valve regulating body 13 arranged in the flow path 12 and being adjustable between a closed position and an open position for the fluid flow. The valve regulating body 13 is rotatable around an axis of rotation 131 between the closed position and the open position. In an embodiment, the valve regulating body 13 is a ball with a through bore, and the control valve loo is a ball valve. Upstream to the valve regulating body 13, there is arranged a flow regulating insert 14 comprising a carrier plate 144 which extends over the cross-section of the valve housing 11. The flow regulating insert 14 comprises two tapered pins 141 and two annular throttling members 142, the annular throttling members 142 each encompassing one of the pins 141, respectively. The annular throttling members 142 are elastically deformable O-rings. The pins 141 and annular throttling members 142 are received in recesses 1441 of the carrier plate 144. The annular throttling members 142 each define an orifice 143 between the pins 141 and a portion 1443 of the carrier plate 144 adjacent to the annular throttling members 142. The carrier plate 144 comprises laterally arranged recesses 1442 which form a seat for the annular throttling members 142.

FIGS. 1b and 1c show magnifications of a part of the flow regulating insert 14 encircled by the circle C in FIG. 1a, for different pressures P1 and P2 of the fluid flow. FIG. 1b shows the configuration for the pin 141 and the annular throttling member 142 received in the recess 1441 of the carrier plate 144 at a pressure P1 of the fluid flow. The pin 141 comprises at one end bridges 1411 which form a retaining surface, such that the annular throttling member 142 may be kept within the carrier plate 144 even if the fluid flow changes the direction of the flow path. The bridges 1411 are connected at an end to a fitting ring 1412. The fitting ring 1412 is received in the recess 1441 in a form-fit and force-fit manner. The fluid may flow across the fluid regulating insert through the space between the bridges 1411. A part of the orifice 143 is defined between the annular throttling member 142 and the pin 141 and another part of the orifice 143 is defined between the annular throttling member 142 and a portion 1443 of the carrier plate 144. FIG. 1c shows the configuration at a pressure P2>P1. The annular throttling member 142 is deformed due to the increased pressure drop across the fluid regulating insert and pressed against the orifice 143 and against the portion 1443 of the carrier plate 144 forming a bearing surface for the annular throttling member 142. Due to the deformation of the throttling member 142, the size of the orifice 143 through which the fluid may flow, is decreased, yielding a regulation of the flow rate. Part of the annular throttling member 142 is pressed into the laterally arranged recesses 1442 forming a seat for the annular throttling member 142.

FIG. 1d shows a front view of the pin 141 and the annular throttling member 142 seen in the direction of the arrow B in FIG. 1b. The pin 141 comprises four bridges 1411 which are connected to the fitting ring 1412. The annular throttling member 142 can be seen through the spaces between the bridges 1412 through which the fluid flow can pass.

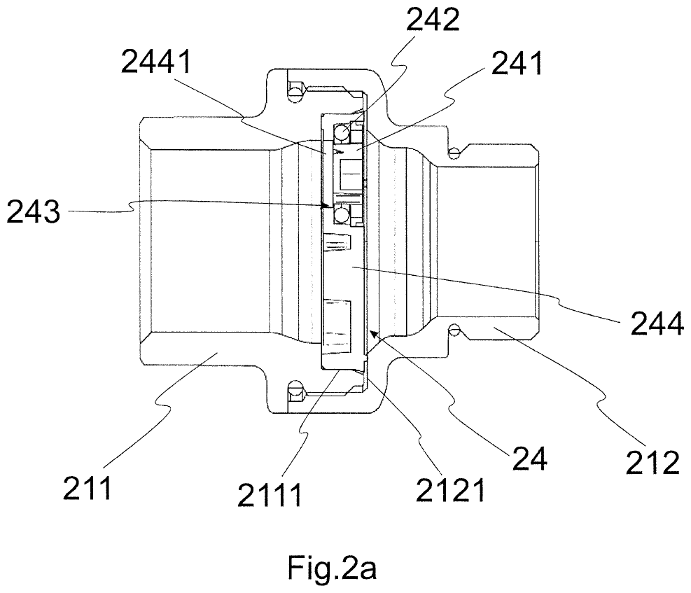

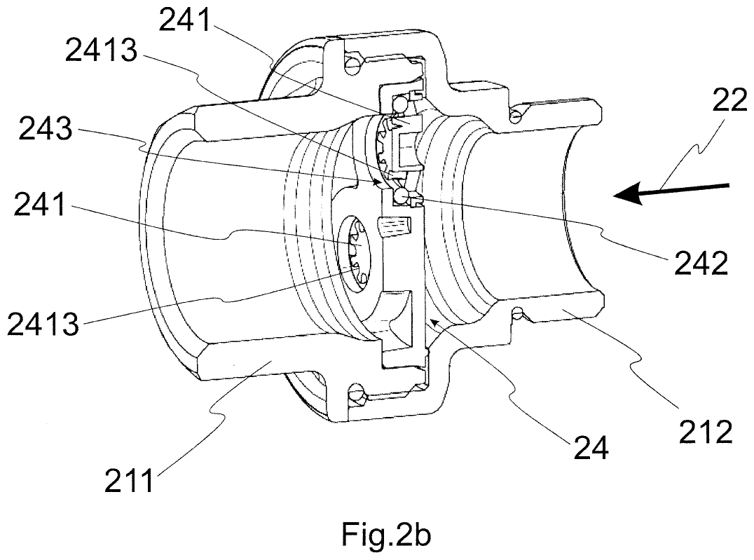

FIG. 2a shows a side cut view of an embodiment of a flow regulating insert 24 with a carrier plate 244 fixedly held between a first valve housing member 211 and a second valve housing member 212 screwed onto the first valve housing member 211. The first valve housing member 211 comprises a circumferential recess 2111 receiving the carrier plate 244. The second valve housing member 212 comprises a bearing surface 2121 onto which the carrier plate 244 abuts such that the carrier plate 244 is clamped in a form-fit manner and force-fit manner between the first and second valve housing member 211, 212. The carrier plate 244 may comprise protrusions which may be deformed while the carrier plate 244 is mounted into the control valve such that the carrier plate 244 can be clamped in a force-fit manner without straining the pins 241 arranged in recesses 2441 of the carrier plate 244. By clamping the carrier plate 244 in the shown manner, leakage and/or vibrations can be avoided. Especially, the fluid flow is restricted to flow through the orifice 243. In FIG. 2a there is shown a pin 241 received in a recess 2441 of the carrier plate 244. The pin 241 is arranged in a spatially fixed manner. An annular throttling member 242 encompasses a protruding part of the pin 241 and defines an orifice 243 between the pin 241 and a portion of the carrier plate 244.

FIG. 2b shows a perspective cut view of the flow regulating insert 24 of FIG. 2a fixedly held between a first valve housing member 211 and a second valve housing member 212 screwed onto the first valve housing member 211. In FIG. 2b, two pins 241 can be seen which are arranged in parallel with respect to the flow path 22. The pins 241 comprise recesses 2413 contributing to the orifice 243. At least a part of the annular throttling member 242 may be compressed into the recesses 2413 of the respective pin 241 under a pressure difference across the flow regulating insert 24, which modifies the orifice for the passage of the fluid flow.

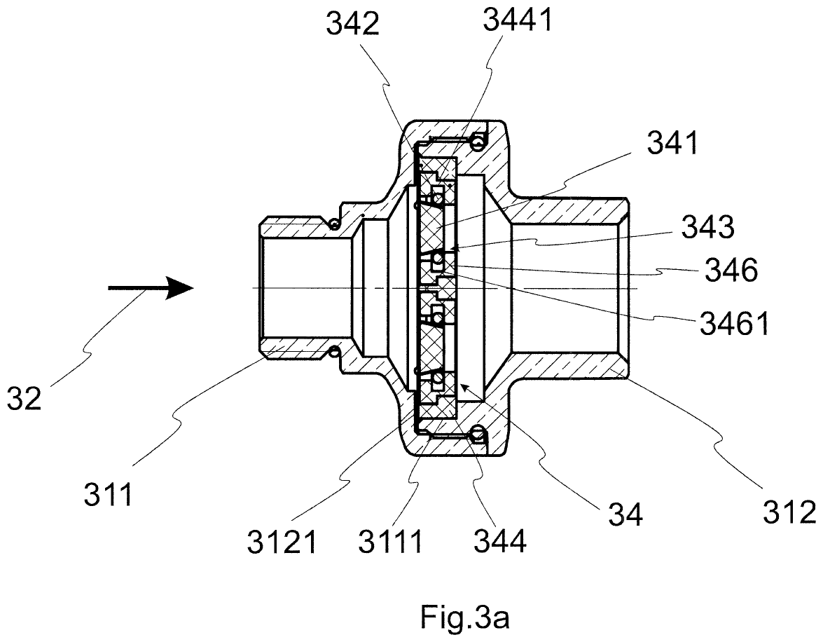

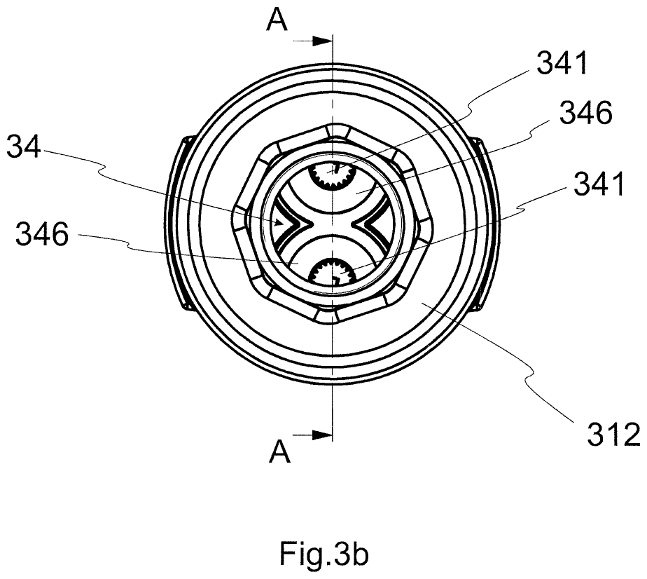

FIG. 3a shows a side cut view of a further embodiment of a flow regulating insert 34 with two pins 341 and two annular throttling members 342. In FIG. 3a, only one of the pins and throttling members is furnished with reference numerals for better visibility. However, both pins and throttling members, respectively, are designed in the same fashion. The pin 341 is arranged in a spatially fixed manner. The annular throttling member 342 encompasses the pin 341. The flow regulating insert 34 further comprises two frame elements 346 arranged in the carrier plate 344 of the flow regulating insert 34 and each receiving the pin 341 and the annular throttling member 342.

The annular throttling member 342 defines an orifice 343 between the pin 341 and a portion of the frame element 346. The frame element 346 comprises laterally arranged recesses 3461 forming a seat for the annular throttling member 342. The carrier plate 344 comprises recesses 3441 for receiving the frame elements 346. The carrier plate 344 receives the frame elements 346 in a form-fit manner and force-fit manner, such that the fluid flow is restricted to flow through the orifices 343. The carrier plate 344 is clamped between a first valve housing member 311 and a second valve housing member 312. The first valve housing member 311 is screwed onto the second valve housing member 312. The second valve housing member 312 comprises a circumferential recess 3111 receiving the carrier plate 344. The first valve housing member 311 comprises a bearing surface 3121 onto which the carrier plate 344 abuts such that the carrier plate 344 is clamped in a form-fit manner and force-fit manner between the first and second valve housing member 311, 312. The flow path is symbolized by the arrow 32.

FIG. 3b shows a rear view of the flow regulating insert 34 of FIG. 3a. The two pins 341 and frame elements 346 arranged within the flow regulating insert 34 can be recognized through the opening of the second valve housing member 312. The line A-A shows the line of cutting for the cut view as shown in FIG. 3a.

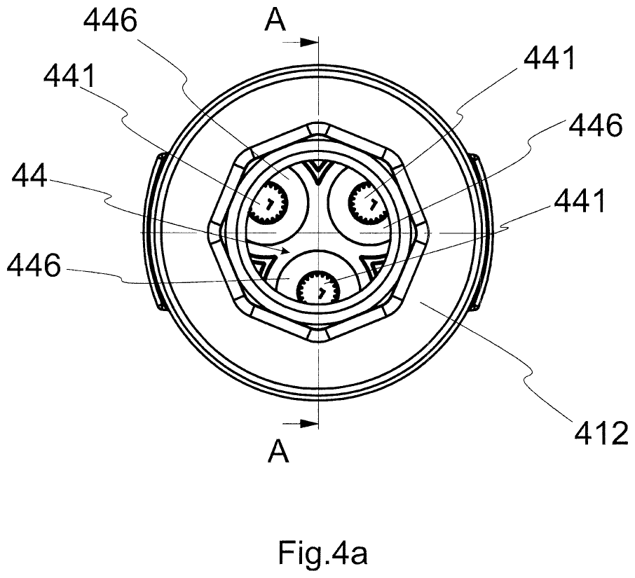

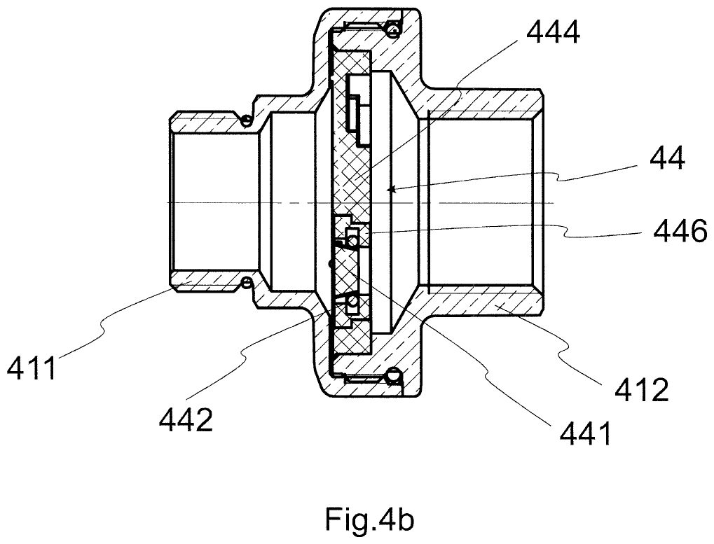

FIG. 4a shows a rear view of a further embodiment of a flow regulating insert 44 with three frame elements 446 and pins 441. The pins 441 and frame elements 446 can be recognized through an opening of a second valve housing member 412.

FIG. 4b shows a side cut view of the flow regulating insert 44 of FIG. 4a where the cut is taken along the line A-A of FIG. 4a. The carrier plate 444 of the flow regulating insert 44 is clamped between a first housing member 411 and the second housing member 412 in a similar fashion as shown for the embodiment of FIG. 3a. Due to the specific arrangement of the three pins 441, only one pin 441 and annular throttling member 442 encompassing the pin 441 and one frame element 446 can be seen in the cut view. The pin 441, the annular throttling member 442 and the frame element 446 have a similar design as shown in the embodiment of FIG. 3a.

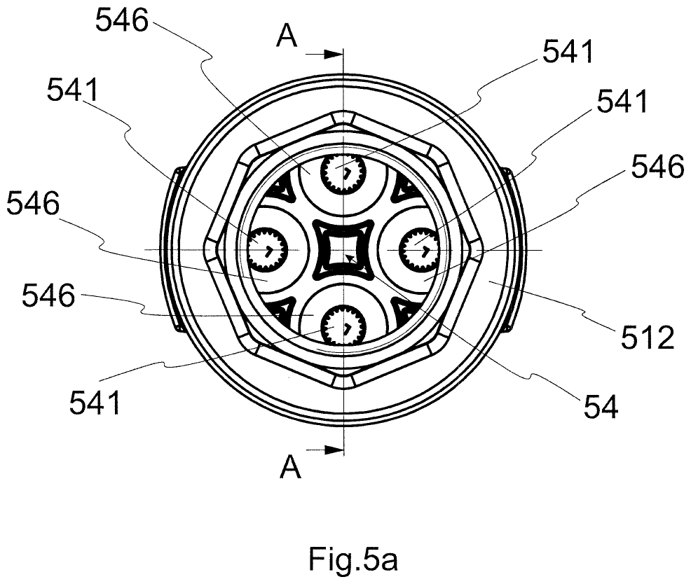

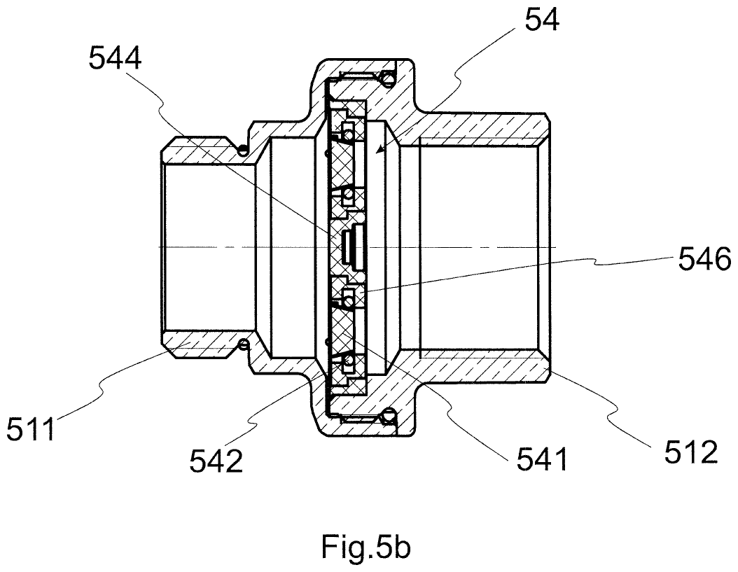

FIG. 5a shows a rear view of a further embodiment of a flow regulating insert 54 with four pins 541 and four frame elements 546. The pins 541 and the frame elements 546 can be recognized through an opening of a second valve housing member 512. A side cut view of the flow regulating insert 54 with the cut taken along the line A-A is shown in FIG. 5b. The carrier plate 544 of the flow regulating insert 54 is clamped between a first housing member 511 and the second housing member 512 in a similar fashion as shown for the embodiment of FIG. 3a or FIG. 4b. The pin 541, the annular throttling member 542 and the frame element 546 have a similar design as shown in the embodiment of FIG. 3a.

The embodiments shown in FIGS. 3a-5b could also be designed without frame elements, in a similar fashion as the embodiments shown in FIGS. 1-2b.

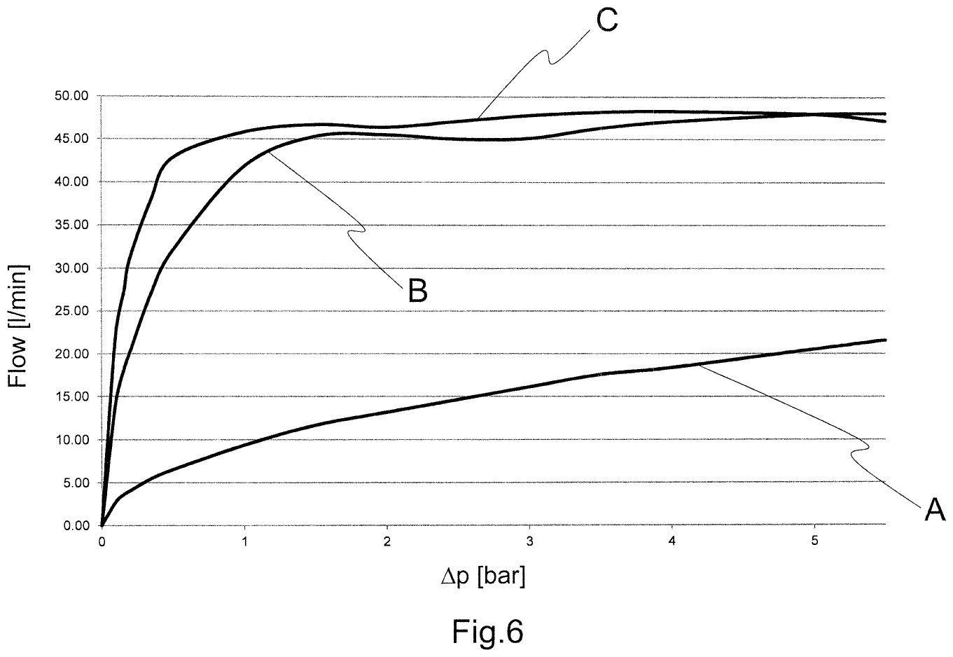

FIG. 6 shows a measurement of the flow rate regulated by a control valve according to the present invention. The flow rate is shown versus the pressure difference across the flow regulating insert. The measurement was taken for an arrangement where the control valve was a ball valve and the flow regulating insert comprised three pins and annular throttling members arranged in parallel with respect to the flow path. The flow regulating insert was installed upstream to the valve regulating body. Curve A shows the measurement for the ball valve being open with an angle of 36.5°. Curve B shows the measurement for an angle of 66.5° and curve C shows the measurement for the fully open ball valve (90°). It can be recognized that the control valve works as a pressure independent valve above a certain minimum Δp-value. Below the minimum Δp-value, the control valve works like a ball valve without flow regulating insert, but with a lower Kᵥ-value. For a fully open valve (90°), the minimum Δp-value is about 0.5 bar, wherein the minimum Δp-value increases with decreasing valve position angles.

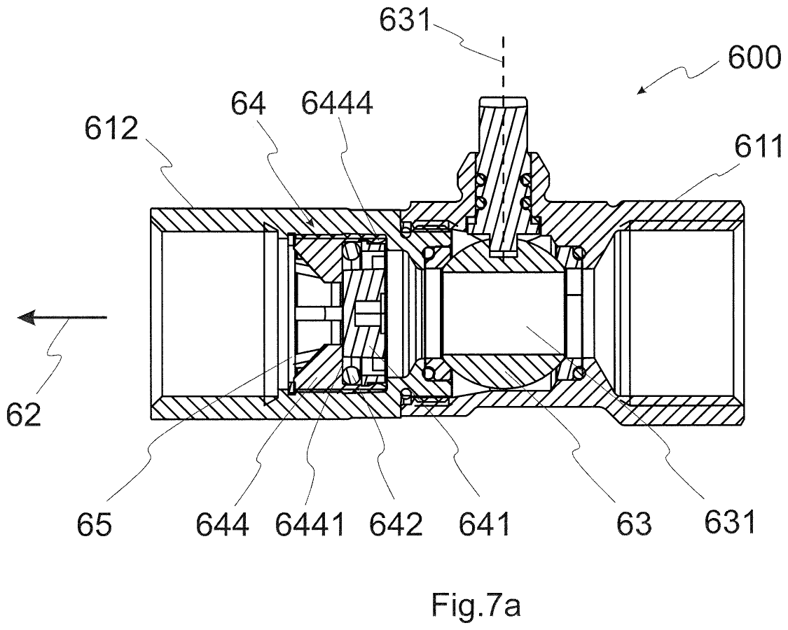

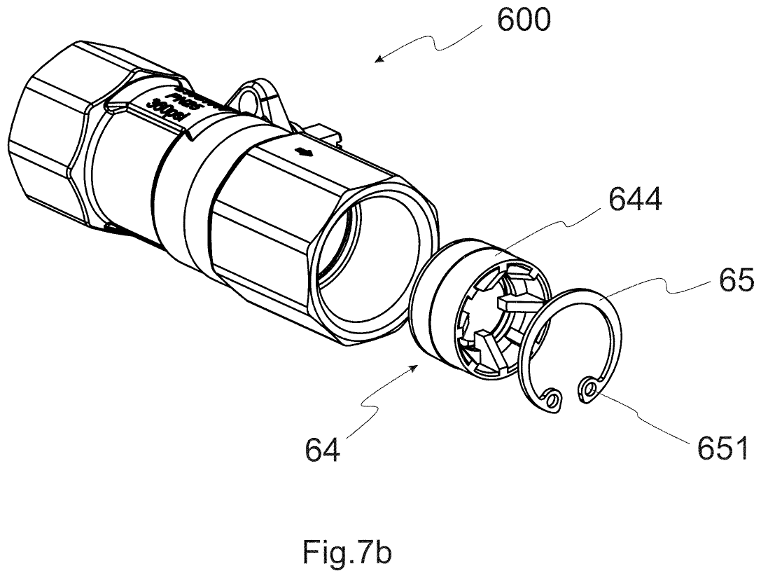

FIG. 7a shows a cross-sectional view of a further embodiment of a control valve 600 designed as a ball valve comprising a valve regulating body 63 shaped as a ball with a through bore 631. The valve regulating body 63 is rotatable around the axis 631. The control valve 600 comprises a first valve housing member 611 accommodating the valve regulating body 63 and a second valve housing member 612 accommodating a flow regulating insert 64. The flow regulating insert 64 comprises a carrier plate in the shape of a cartridge 644 extending over the cross-section of the second valve housing member 612. The cartridge 644 comprises a recess 6441 receiving a pin 641 and an annular throttling member 642. The annular throttling member 642 encompasses the pin 641. The cartridge 644 comprises lateral latches 6444 configured to catch the pin 641 in a latching fashion. The flow regulating insert 64 is arranged downstream to the valve regulating body 63, as indicated by the flow path 62. Further, the flow regulating insert 64 is held in place by a fitting clip 65, as better visible in FIG. 7b.

FIG. 7b shows an exploded perspective view of the control valve 600 of FIG. 7a showing the flow regulating insert 64 and the cartridge 644. The fitting clip 65 comprises two ends with holes 651 which can be used to catch and remove or insert the clip 65. Thus, the shown embodiment is particularly suitable for interchanging different flow regulating inserts 63 with different flow regulating characteristics, depending on the specific application of the control valve 600.

1. A control valve for regulating a fluid flow in an HVAC system,
the control valve comprising
a valve housing defining a flow path,
a valve regulating body arranged in the flow path and being adjustable between a closed position and an open position for the fluid flow, and
at least one flow regulating insert configured to regulate the fluid flow over a range of pressure differences across the flow regulating insert,
wherein
the flow regulating insert comprises a spatially fixed pin and an elastically deformable annular throttling member encompassing at least a part of the pin, wherein the annular throttling member defines an orifice in the flow regulating insert for the passage of the fluid flow, the orifice, being modifiable by deformation of the annular throttling member under a pressure difference across the flow regulating insert.

2. The control valve according to claim 1, wherein the flow regulating insert comprises at least two spatially fixed pins and at least two elastically deformable annular throttling members, each encompassing at least a part of one of the pins.

3. The control valve according to claim 1, wherein the flow regulating insert comprises a carrier plate extending across the cross-section of the valve housing at the position of the flow regulating insert and comprising a recess for receiving the pin and the annular throttling member, wherein the annular throttling member defines the orifice between the pin and a portion of the carrier plate.

4. The control valve according to claim 1, wherein the flow regulating insert comprises a frame element for receiving the pin and the annular throttling member, wherein the annular throttling member defines the orifice between the pin and a portion of the frame element, the flow regulating insert comprising a carrier plate extending across the cross-section of the valve housing at the position of the flow regulating insert and comprising a recess for receiving the frame element.

5. The control valve according to claim 4, wherein the frame element comprises a recess forming a seat for the annular throttling member.

6. The control valve according to claim 1, wherein the valve housing comprises a recess for receiving the flow regulating insert.

7. The control valve according to claim 1, wherein the valve housing comprises a first and second valve housing member, wherein the flow regulating insert is fixedly held between the first and second valve housing member.

8. The control valve according to claim 1, wherein the valve regulating body is rotatable around an axis of rotation between the closed position and the open position for the fluid flow.

9. The control valve according to claim 8, wherein the valve regulating body is a ball with a through bore.

10. The control valve according to claim 1, wherein the flow regulating insert is arranged within the valve regulating body.

11. The control valve according to claim 1, wherein the flow regulating insert is arranged upstream or downstream of the valve regulating body with respect to the flow path.

12. The control valve according to claim 1, wherein the flow regulating insert comprises a recess contributing to the orifice for the passage of the fluid flow.

13. The control valve according to claim 1, wherein the control valve is a 6-way valve comprising two consumer ports and four source ports, wherein the four source ports comprise two first source ports for a first fluidic circuit and two second source ports for a second fluidic circuit, wherein a flow regulating insert of the at least one flow regulating insert is arranged in at least one of: the two consumer ports and the four source ports.

14. The control valve according to claim 13, wherein the control valve comprises a first flow regulating insert of the at least one flow regulating insert and a second flow regulating insert of the at least one flow regulating insert, wherein the first and second flow regulating inserts are configured to regulate the flow rate to a first and a different second specific value, respectively.

15. A flow regulating insert for positioning in a flow path of a control valve according to claim 1, comprising a spatially fixed pin and an elastically deformable annular throttling member encompassing at least a part of the pin, wherein the annular throttling member defines an orifice in the flow regulating insert for the passage of the fluid flow, the orifice being modifiable by deformation of the annular throttling member under a pressure difference across the flow regulating insert.

16. The flow regulating insert according to claim 13, wherein the flow regulating insert comprises at least two spatially fixed pins and at least two elastically deformable annular throttling members, each encompassing at least a part of one of the pins.

17. The flow regulating insert according to claim, wherein the flow regulating insert comprises a carrier plate comprising a recess for receiving the pin and the annular throttling member, wherein the annular throttling member defines the orifice between the pin and a portion of the carrier plate.

18. The flow regulating insert according to claim 13, wherein the flow regulating insert comprises a frame element for receiving the pin and the annular throttling member, wherein the annular throttling member defines the orifice between the pin and a portion of the frame element, the flow regulating insert comprising a carrier plate comprising a recess for receiving the frame element.

19. The flow regulating insert according to claim 13, wherein the flow regulating insert comprises a recess contributing to the orifice for the passage of the fluid flow.
